(19) United States
(12) Patent Application Publication
(10) Pub. No.: US 2026/0178597 A1
(43) Pub. Date: Jun. 25, 2026

(54) METHOD, APPARATUS, DEVICE, STORAGE MEDIUM AND PROGRAM PRODUCT FOR REPLY PROVISION

(71) Applicant: Beijing Zitiao Network Technology Co., Ltd., Beijing (CN)

(72) Inventors: Han WANG, Beijing (CN); Mengqian Liu, Beijing (CN); Xujie Tao, Beijing (CN); Jia Guo, Beijing (CN); Shuo Liu, Beijing (CN); Xiaolin Li, Beijing (CN)

(21) Appl. No.: 19/349,931

(22) Filed: Oct. 3, 2025

(30) Foreign Application Priority Data
Dec. 20, 2024 (CN) 202411899868.X

(51) Int. Cl. G06F 16/2458; G06F 9/445

(52) U.S. Cl. CPC G06F 16/2462; G06F 9/44526

(57) ABSTRACT

The disclosure provides a method, an apparatus, a device, a storage medium and a program product for reply provision. The method includes: receiving a query request; generating, using a target machine learning model, a first model output based on the query request, the first model output including an invocation marker for an invocation of a first plug-in and a first invocation parameter for the first plug-in; obtaining a first invocation result of the first plug-in by invoking the first plug-in using the first invocation parameter; and determining a reply to the query request at least based on the first invocation result.

### CROSS-REFERENCE

The present application claims priority to Chinese Patent Application No. 202411899868.X, filed on Dec. 20, 2024 and entitled “METHOD, APPARATUS, DEVICE, STORAGE MEDIUM AND PROGRAM PRODUCT FOR REPLY PROVISION”, the entirety of which is incorporated herein by reference.

### FIELD

Example embodiments of the present disclosure generally relate to the field of computers, and in particular, to a method, an apparatus, a device, a storage medium and a program product for reply provision.

### BACKGROUND

With the development of information technology, various electronic devices can provide people with a variety of services in work and daily life. For example, service-providing applications may be deployed on client devices. A client device or an application can provide users with digital-assistant functions to assist them in using the client device or application. Users can carry out diverse operations through various interactions with the digital assistant.

### SUMMARY

In a first aspect of the present disclosure, there is provided a method for reply provision. The method includes: receiving a query request; generating, using a target machine learning model, a first model output based on the query request, the first model output including an invocation marker for an invocation of a first plug-in and a first invocation parameter for the first plug-in; obtaining a first invocation result of the first plug-in by invoking the first plug-in using the first invocation parameter; and determining a reply to the query request at least based on the first invocation result.

In a second aspect of the present disclosure, there is provided an apparatus for reply provision. The apparatus includes: a query request reception module configured to receive a query request; a first output generation module configured to generate, using a target machine learning model, a first model output based on the query request, the first model output including an invocation marker for an invocation of a first plug-in and a first invocation parameter for the first plug-in; an invocation result obtaining module configured to obtain a first invocation result of the first plug-in by invoking the first plug-in using the first invocation parameter; and a reply determination module configured to determine a reply to the query request at least based on the first invocation result.

In a third aspect of the present disclosure, there is provided an electronic device. The electronic device includes: at least one processor; and at least one memory coupled to the at least one processor and storing instructions for execution by the at least one processor, the instructions, when executed by the at least one processor, causing the electronic device to perform the method according to the first aspect of the present disclosure.

In a fourth aspect of the present disclosure, there is provided a computer-readable storage medium having stored thereon a computer program, the computer program, when executed by a processor, causing the processor to perform the method according to the first aspect of the present disclosure.

In a fifth aspect of the present disclosure, there is provided a computer program product. The computer program product is tangibly stored in a computer storage medium and includes computer-executable instructions, the computer-executable instructions, when executed by a device, causing the device to perform the method according to the first aspect of the present disclosure.

It should be understood that the content described in this Summary section is not intended to limit key or essential features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages and aspects of the embodiments of the present disclosure will become more apparent from the following description in conjunction with the accompanying drawings. In the drawings, the same or similar reference numerals denote the same or similar elements, in which:

FIG. 1A illustrates a schematic diagram of an example environment in which embodiments of the present disclosure can be implemented;

FIG. 1B illustrates an example of determining a reply by invoking a plug-in;

FIG. 2A illustrates an example of reply provision according to some embodiments of the present disclosure;

FIG. 2B illustrates an example of a knowledge graph according to some embodiments of the present disclosure;

FIG. 3 illustrates a flowchart of a method for reply provision according to some embodiments of the present disclosure;

FIG. 4 illustrates an example structural block diagram of an apparatus for reply provision according to some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although certain embodiments of the present disclosure are illustrated in the drawings, it should be understood that the present disclosure may be implemented in various forms and should not be construed as limited to the embodiments set forth herein. On the contrary, the embodiments are provided so as to enable a thorough and complete understanding of the present disclosure. It should be understood that the drawings and embodiments of the present disclosure are for illustrative purposes only and are not intended to limit the scope of the present disclosure.

In the description of the embodiments of the present disclosure, the term “comprise” and similar terms should be understood as open-ended inclusion, that is, “comprising but not limited to.” The term “based on” should be understood as “at least partially based on.” The term “an embodiment” or “the embodiment” should be understood as “at least one embodiment.” The term “some embodiments” should be understood as “at least some embodiments.” Other explicit and implicit definitions may also be included below.

In this disclosure, unless expressly specified, performing a step “in response to A” does not mean performing the step immediately after “A,” but may include one or more intermediate steps.

It may be understood that data (including but not limited to the data itself, the obtaining, using, storing or deleting of the data) involved in the technical solution(s) provided herein should follow the requirements of the corresponding laws and regulations and related regulations.

It can be understood that, before using the technical solutions disclosed in the embodiments of the present disclosure, informing the user of the types, scope of use, usage scenarios and other aspects of personal information involved in the present disclosure, and obtaining user authorization, should be carried out by appropriate means in accordance with relevant laws and regulations.

For example, in response to receiving an active request from a user, prompt information may be sent to the user to explicitly inform the user that the operation requested to be performed will require obtaining and using the user's personal information, so that the user can independently choose, according to the prompt information, whether to provide personal information to electronic devices, applications, servers, or storage media, etc., that perform the operation of the technical solutions of the present disclosure.

As an example but non-limiting implementation, in response to receiving an active request from a user, the manner of sending prompt information to the user may be, for example, in the form of a pop-up window, in which the prompt information may be presented in text. In addition, the pop-up window may further contain selection controls for the user to choose “agree” or “disagree” to provide personal information to the electronic device.

It can be understood that the above process of notification and obtaining user authorization is merely schematic and does not constitute a limitation on the implementations of the present disclosure. Other approaches that comply with relevant laws and regulations can also be applied to the implementations of the present disclosure.

As used herein, the term “model” may learn the association relationship between corresponding inputs and outputs from training data, so that after training, corresponding outputs may be generated for given inputs. The generation of the model may be based on machine learning techniques. Deep learning is a type of machine learning algorithm that processes inputs and provides corresponding outputs by using multiple processing units. A neural network model is an example of a model based on deep learning. In this disclosure, the term “model” may also be referred to as a “machine learning model,” “learning model,” “machine learning network,” or “learning network,” and these terms are used interchangeably herein.

A “neural network” is a machine learning network based on deep learning. A neural network may process inputs and provide corresponding outputs, and generally includes an input layer, an output layer, and one or more hidden layers between the input layer and the output layer. Neural networks used in deep learning applications typically include many hidden layers, thereby increasing the depth of the network. The respective layers of the neural network are sequentially connected, such that the output of a preceding layer is provided as the input to a subsequent layer, where the input layer receives the input of the neural network, and the output of the output layer is used as the final output of the neural network. Each layer of the neural network includes one or more nodes (also referred to as processing nodes or neurons), and each node processes inputs from the preceding layer.

In general, machine learning may include three stages, namely a training stage, a testing stage, and an application stage (also referred to as an inference stage). In the training stage, a given model may be trained with a large amount of training data, iteratively updating parameter values until the model can achieve consistent inferences from the training data that meet expected objectives. Through training, the model may be considered to have learned the correlation between inputs and outputs from the training data (also referred to as the mapping from input to output). The parameter values of the trained model are determined. In the testing stage, test inputs are applied to the trained model to test whether the model can provide correct outputs, thereby determining the performance of the model. The testing stage may sometimes be integrated into the training stage. In the application or inference stage, the trained model may be used to process actual model inputs based on the parameter values obtained through training, and to determine corresponding model outputs.

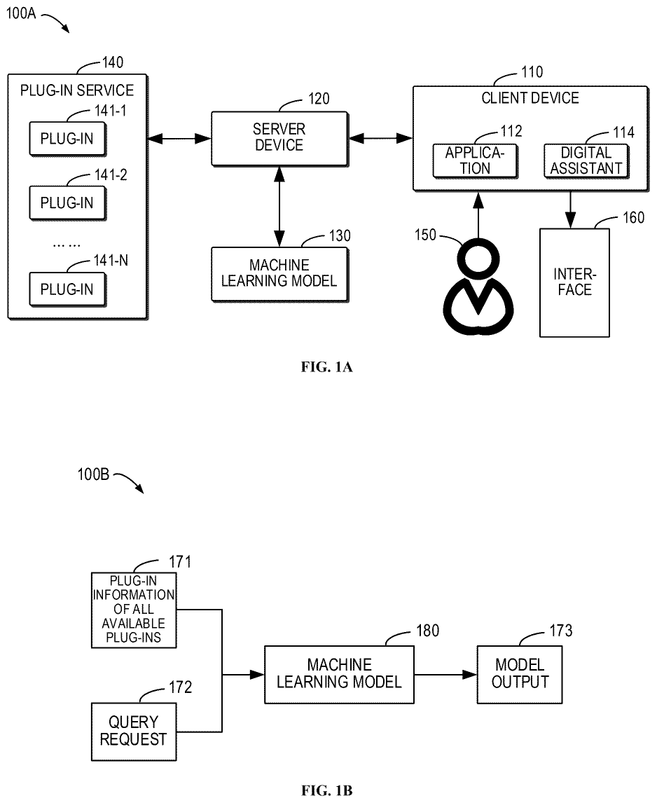

FIG. 1A illustrates a schematic diagram of an example environment 100A in which embodiments of the present disclosure can be implemented. In the example environment 100A, an application 112 and a digital assistant 114 are installed in a client device 110. In some embodiments, the application 112 and the digital assistant 114 may be downloaded and installed on the client device 110. In some embodiments, the application 112 and the digital assistant 114 may also be accessed in other ways, for example, through web access. A user 150 may interact with the application 112 and/or the digital assistant 114 via the client device 110 and/or an attached device of the client device 110.

In embodiments of the present disclosure, the application 112 may be any suitable application with a reply function, which may include but is not limited to one or more of the following: a chat application component (also referred to as an instant messaging application component), a browser application component, a planning application component, a document application component, an audio and video conferencing application component, an email application component, a task application component, a calendar application component, and an objectives and key results (OKR) application component, and so on. It can be understood that although a single application 112 is illustrated in FIG. 1A, multiple applications 112 may actually be installed on the client device 110.

In some embodiments, the application 112 may include a multifunctional collaboration platform, such as an office collaboration platform (also referred to as an office suite), which is capable of providing integration of multiple types of business components to facilitate office work, communication and other activities. In the multifunctional collaboration platform, users may start different business components as needed to perform corresponding information processing, sharing, communication, and so on. The digital assistant 114 may be provided by a separate application, or may be integrated into a certain application 112 that is capable of providing content entities. The application providing a client interface for the digital assistant may correspond to a single-function application component or a multifunctional collaboration platform, such as an office suite or other collaboration platforms capable of integrating multiple components. It can be understood that, similar to the application 112, although a single digital assistant 114 is illustrated in FIG. 1A, multiple digital assistants may actually be present.

The digital assistant 114 is an intelligent assistant of the user and has intelligent dialogue and information processing capabilities. In embodiments of the present disclosure, the digital assistant 114 is used for interaction with the user 150 to assist the user 150 in using the client device or the application. In some embodiments, multiple interaction modes between the user 150 and the digital assistant 114 may be provided, and flexible switching between the multiple interaction modes may be enabled. When a certain interaction mode is triggered, a corresponding interaction area is presented to facilitate the interaction between the user 150 and the digital assistant 114. The interaction manner between the user 150 and the digital assistant 114 differs under different interaction modes, so that the interaction requirements in different application scenarios may be flexibly adapted.

In the environment 100A, in response to the application 112 being launched, the client device 110 may present an interface 160 of the application 112 and/or the digital assistant 114. The interface 160 may include, for example, an interaction interface of the application 112 and the digital assistant 114. In some embodiments, an interaction window between the user 150 and the digital assistant 114 may be presented in the interface 160. In the interaction window, the user 150 may conduct a dialogue with the digital assistant 114 by inputting natural language, image files, audio files, video files, web files, and so on, so as to instruct the digital assistant to assist in completing various tasks.

The interaction window between the digital assistant 114 and the user 150 may include a conversation window, for example, a conversation window in an instant messaging application or in an instant messaging module of a specific application. In the conversation window, the interaction between the digital assistant 114 and the user 150 may be presented in the form of conversation messages. Alternatively or additionally, the interaction window between the digital assistant 114 and the user 150 may further include other types of windows, for example, a window in a floating window mode, in which the user 150 may trigger the digital assistant 114 to perform a corresponding operation by inputting commands, selecting shortcut commands, and the like.

In some embodiments, the digital assistant 114 may support an interaction mode of a conversation window, also referred to as a conversation mode. In this interaction mode, a conversation window between the user 150 and the digital assistant 114 is presented, and in the conversation window the user 150 and the digital assistant 114 interact with each other through conversation messages. In the conversation mode, the digital assistant 114 may perform tasks based on the conversation messages in the conversation window. In the interaction window, the user 150 inputs interaction messages, and the digital assistant 114 provides reply messages in response to the user input. By selecting the digital assistant 114, a conversation window with the digital assistant 114 may be opened. The conversation window may include interface elements for information interaction, such as an input box, a message list, message bubbles, and so on.

The digital assistant 114 is provided to assist the user 150 with various task processing requirements in different applications and scenarios. The digital assistant 114 generally has intelligent dialogue and task processing capabilities. In the interaction with the digital assistant 114, the user 150 inputs a user request (for example, dialogue content in the form of text, voice, image, video, or other modalities), and the digital assistant 114 provides a reply to the user request in response to the user input. Generally, the digital assistant 114 may support the user 150 in inputting questions in natural language, and perform tasks and provide replies based on the understanding of the natural language input and logical reasoning capabilities.

In some embodiments, the digital assistant 114 supports the use of plug-ins. Such plug-ins may include but are not limited to one or more of the following: a search plug-in, a contacts plug-in, a messaging plug-in, a document plug-in, a spreadsheet plug-in, an email plug-in, a calendar plug-in, a scheduling plug-in, a task plug-in, and so on. Each plug-in is configured to provide one or more functions of an application. Generally, a plug-in may be understood as a collection of functions, and a “tool” in a plug-in may be understood as a unit function or atomic function within the plug-in. With the aid of multiple tools, the plug-in may ultimately be used to process a category of tasks desired by the user. For example, a plug-in for processing documents may include: a document creation tool configured to create a new document; a search tool configured to perform a search in the document; a formula generation tool configured to generate and insert formulas in the document; and so on.

In embodiments of the present disclosure, a plug-in service 140 provides the user 150 with an environment for creation, publishing, storage, and application of plug-ins 141. The plug-in service 140 may be deployed with, for example, a database (which may also be referred to as a knowledge base), in which the created plug-ins 141 are stored. For example, multiple plug-ins 141 such as plug-in 141-1, plug-in 141-2, . . . , and plug-in 141-N may be stored in the plug-in service 140. It should be noted that the plug-in service 140 may be deployed at a server device 120, or may be deployed at another device. In embodiments of the present disclosure, for the sake of description, the case where the plug-in service 140 is deployed at the server device 120 is taken as an example for illustration.

In some embodiments, the user 150 may input a conversation message in the conversation window of the digital assistant 114, and the digital assistant 114 may request the plug-in service 140 to assist in invoking a plug-in 141 based on a plug-in definition of the plug-in 141, obtain feedback information from the plug-in 141, determine a reply message based on the feedback information, and present the reply message to the user in the conversation window.

In some embodiments, a communication connection is established between the client device 110 and the server device 120. The communication connection may be established in a wired manner or a wireless manner. The communication connection may include but is not limited to a Bluetooth connection, a mobile network connection, a universal serial bus (USB) connection, a wireless fidelity (WiFi) connection, and the like, and embodiments of the present disclosure are not limited in this regard. In embodiments of the present disclosure, signaling interaction between the client device 110 and the server device 120 may be implemented through the communication connection therebetween so as to provide services of the application 112 and/or the digital assistant 114.

As shown in FIG. 1A, the server device 120 may invoke a machine learning model 130. It may be understood that the machine learning model 130 may include one or more machine learning models, that is, the server device 120 may invoke one or more machine learning models, and the one or more machine learning models may be collectively referred to as the machine learning model 130. It should be noted that if the machine learning model 130 includes multiple machine learning models, the multiple machine learning models may have different purposes and functions, and the present disclosure is not limited in this regard.

The machine learning model 130 may be deployed at the server device 120 or may be deployed at another device. The machine learning model 130 may be based on any suitable model architecture, including but not limited to a Transformer model, a convolutional neural network (CNN), a recurrent neural network (RNN), a deep neural network (DNN), and so on. In some embodiments, the machine learning model 130 may be based on a language model (LM). A language model, by learning from a large amount of corpus, can have question-answering capabilities. The machine learning model 130 may also be based on other suitable models.

The client device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communications system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices or any combination thereof. In some embodiments, the client device 110 may also support any type of user interface, such as a wearable circuit.

The server device 120 may be an independent physical server, or a server cluster or a distributed system composed of multiple physical servers, or a cloud server providing basic cloud computing services such as cloud services, cloud databases, cloud computing, cloud functions, cloud storage, network services, cloud communications, middleware services, domain name services, security services, content delivery networks, and big data and artificial intelligence platforms. The server device 120 may, for example, include computing systems/servers, such as mainframes, edge computing nodes, computing devices in a cloud environment, and so on.

It should be understood that the structures and functions of the elements in the environment 100A are described merely for purposes of illustration and do not imply any limitation on the scope of the present disclosure.

As mentioned above, an application providing services may be deployed in the client device. The client device or the application may provide digital assistant functions to the user to assist the user in using the client device or the application. The user may perform diverse operations through different interactions with the digital assistant. As an example, in the case of providing reply services, the client device may receive a query request sent by the user for the digital assistant. The client device may send the received query request to the server device. The server device may determine a reply to the query request according to a trained machine learning model. The server device may further determine whether it is necessary to determine the reply with the aid of a plug-in, and, if it is determined that a plug-in is needed, invoke the plug-in and determine the reply based on the invocation result of the plug-in. The server device may provide the determined reply to the client device so that the client device may provide the reply to the user.

FIG. 1B illustrates an example of determining a reply by invoking a plug-in. As shown in FIG. 1B, in the related art, plug-in information 171 of all available plug-ins that may be invoked (for example, including a plug-in name, a plug-in description, and the like) is typically provided together with a query request 172 to a machine learning model 180, where the machine learning model 180 may be, for example, a specific machine learning model among the machine learning models 130 described above. The machine learning model 180 may determine, based on the query request 172, whether it is necessary to invoke a plug-in, and, when it is determined that a plug-in needs to be invoked, determine at least one plug-in to be invoked from all available plug-ins based on the plug-in information 171 of all available plug-ins and the query request 172. Subsequently, the at least one determined plug-in is invoked to obtain an invocation result, and a model output 173 is determined based on the invocation result. This causes the machine learning model 180 to receive and process a large amount of plug-in information each time a reply is determined, so as to decide whether a plug-in needs to be invoked. This increases a computational cost of the machine learning model and reduces the efficiency of the machine learning model in generating replies. On the other hand, the machine learning model 180 needs to rely on its own understanding ability to decide whether a plug-in needs to be invoked and which plug-in(s) need to be invoked, which places high requirements on the accuracy of the machine learning model 180 in information processing and demand determination. Therefore, in many cases, the machine learning model 180 cannot correctly determine and stably perform plug-in invocation, which affects the accuracy of the final reply.

In view of this, according to embodiments of the present disclosure, an improved solution for reply provision is provided. According to the solution of embodiments of the present disclosure, a query request is received. A first model output is generated, using a target machine learning model, based on the query request. The first model output includes an invocation marker for an invocation of a first plug-in and a first invocation parameter for the first plug-in. The first plug-in is invoked using the first invocation parameter to obtain a first invocation result of the first plug-in. A reply to the query request is determined at least based on the first invocation result.

According to the foregoing solution, the machine learning model is configured to explicitly output an invocation marker when a plug-in invocation requirement of the query request is detected. In this way, the model may be constrained to always accurately generate an indication of plug-in invocation when the query request needs to be processed by invoking a plug-in, which is particularly advantageous for a model structure that performs content generation in an autoregressive manner. In addition, since the model may be used to determine which plug-ins need to be invoked and invoke the plug-ins in a targeted manner, without providing the model with a large amount of plug-in information, this may reduce the computational power consumption of the model in processing a large number of plug-ins and improve the efficiency of invoking plug-ins and determining replies.

Some example embodiments of the present disclosure will be described below with continued reference to the accompanying drawings.

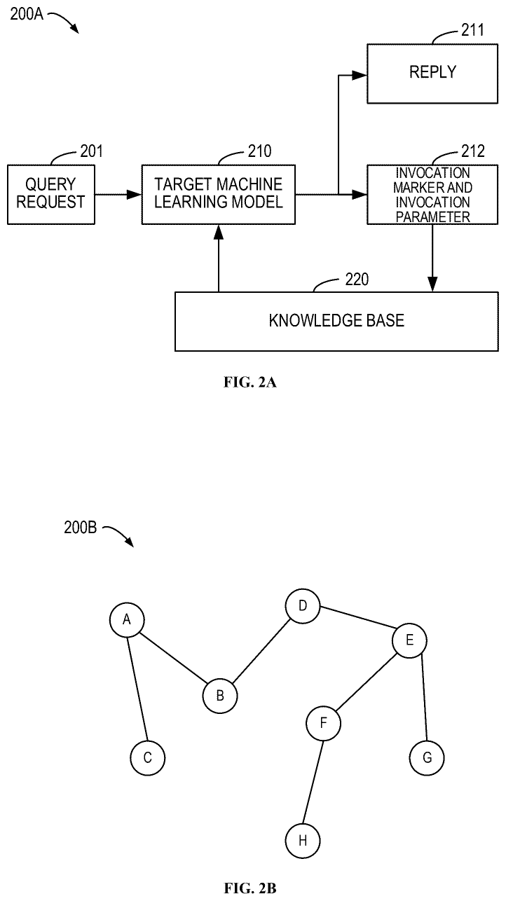

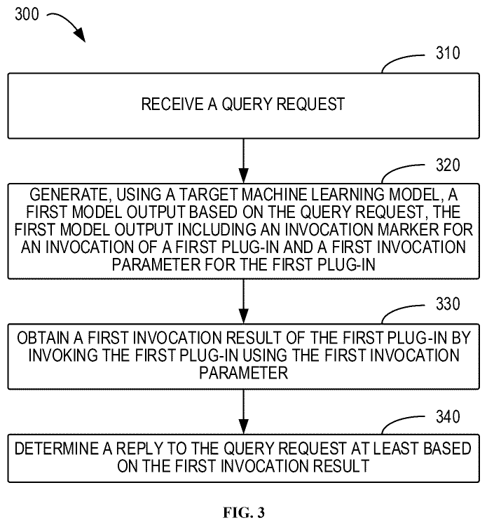

FIG. 2A illustrates an example 200A of reply provision according to some embodiments of the present disclosure. For ease of discussion, the example 200A will be described with reference to the environment 100 of FIG. 1A. The example 200A may be implemented at the client device 110 and/or the server device 120. For convenience of description, the case where the example 200A is implemented at the server device 120 is taken as an example for illustration.

It should be noted that if the case where the example 200A is implemented at the client device 110 is taken as an example for illustration, some operations described with reference to the client device 110 may need to be completed with the assistance of the server device 120. It should be understood that the operations performed by the client device 110 may specifically be performed by a related application and/or the digital assistant installed on the client device 110.

The client device 110 may receive a query request 201. As an example, the query request 201 may be a query request directed to a specific application or a digital assistant. For example, the client device 110 may receive, during an interaction between a user (for example, the user 150) and a digital assistant (for example, the digital assistant 114), a query request 201 sent by the user directed to the digital assistant. As an example, the interaction may include a conversational interaction via a user interface, a voice interaction via a speaker/microphone, and so on. The client device 110 may receive the query request 201 in any suitable manner. For example, the client device 110 may receive a voice-type query request 201 input by the user via a microphone, a text-type query request 201 input by the user via an input box, a gesture-type query request 201 input by the user via a camera, and so on. The present disclosure does not impose any limitation on the manner in which the query request 201 is received.

The client device 110 may provide the received query request 201 to the server device 120 such that the server device 120 receives, during the interaction between the user and the digital assistant, the query request 201 directed to the digital assistant. In some embodiments, if the content type of the query request 201 is a non-text type (for example, a voice type), the client device 110 may convert the query request 201 into a text type and provide the text-type query request 201 to the server device 120. In other embodiments, the client device 110 may also directly provide the non-text type query request 201 to the server device 120, and the server device 120 may perform conversion on the non-text type query request 201 by itself to convert it into a text type. Hereinafter, by way of example, the case where the server device 120 acquires the text-type query request 201 will be described.

The server device 120 may determine, using a target machine learning model 210 and based on the query request 201, an invocation marker for an invocation of a first plug-in and a first invocation parameter for the first plug-in (that is, the invocation marker and invocation parameter 212 in FIG. 2A). The target machine learning model 210 may be any suitable machine learning model among the machine learning models 130. The target machine learning model 210 may be a generative model, the input of which is represented in the form of a sequence and the model output of which is also in the form of a sequence. In some embodiments, the target machine learning model 210 may generate a model output in an autoregressive manner. According to the autoregressive manner, the target machine learning model 210 iteratively predicts, one by one, output units in an output sequence. At each generation step, the target machine learning model 210 always predicts the next output unit based on the input sequence and one or more previously generated output units. Such a machine learning model may, for example, be based on a language model. As an example, the target machine learning model 210 may be a multimodal large language model (MLLM).

In some embodiments, the server device 120 may acquire a prompt template for the target machine learning model 210, and generate a prompt for the server device 120 based on the prompt template. For example, the server device 120 may determine a prompt for the target machine learning model 210 by filling the query request 201 into the prompt template. In other embodiments, the server device 120 may also acquire a system prompt for the target machine learning model 210, and determine a prompt for the target machine learning model 210 based on the system prompt. The server device 120 may guide the target machine learning model 210 to generate different model outputs by providing different prompts to the target machine learning model 210.

The server device 120 may, for example, generate a prompt for the target machine learning model 210 based on the query request 201, and guide the machine learning model to generate a model output for the query request 201 by providing the prompt to the target machine learning model 210. In some embodiments, the target machine learning model 210 may determine whether the query request 201 includes an intention to invoke a plug-in. For example, the target machine learning model 210 may determine whether the semantics of the query request 201 includes an intention to invoke a plug-in by performing semantic analysis on the query request 201. The target machine learning model 210 may, in response to determining that the intention to invoke a plug-in is not included, directly generate a model output including a reply 211 to the query request 201 based on the query request 201.

The target machine learning model 210 may further, in response to determining that the intention to invoke a plug-in is included, generate a model output including an invocation marker for an invocation of the first plug-in and a first invocation parameter for the first plug-in (which may be referred to as a first model output). The first plug-in may include one or more plug-ins determined by the target machine learning model 210 to be invoked for determining a reply to the query request 201. That is, the reply to the query request 201 is generated at least based on the invocation result of the first plug-in. The invocation marker may include a sequence start symbol indicating a plug-in invocation (for example, the symbol “SOF”), a plug-in invocation symbol (for example, the symbol “API_CALL”), and a sequence end symbol indicating a plug-in invocation (for example, the symbol “EOF”). In the autoregressive manner, after the target machine learning model 210 generates the first invocation marker, for example, the sequence start symbol, the subsequent generation will be constrained to continue to generate content related to the plug-in invocation, including other invocation markers and an indication of the plug-in to be invoked.

With respect to the training manner of the target machine learning model 210, it may be understood that the target machine learning model 210 may be trained at any suitable electronic device, and herein the case where the target machine learning model 210 is trained at the server device 120 is merely taken as an example for illustration. The server device 120 may acquire a training dataset for training the target machine learning model 210, where the training dataset may include a plurality of sample queries and annotation information for each sample query. For each sample query, the corresponding annotation information may include an invocation marker for an invocation of the sample plug-in and an invocation parameter for the sample plug-in, and the sample plug-in is invoked for determining the reply 211 to the sample query.

Referring to Table 1, Table 1 illustrates some examples of sample queries and corresponding annotation information:

TABLE 1

| Sample Query | Annotation Information |
|---|---|
| Please tell me how the | [SOF API_CALL({“api”: “Weather_API”, |
| weather is today? | “parameters”: {“date”: “today”}}) EOF] |
| What are the latest news? | [SOF API_CALL({“api”: “News_API”, |
| | “parameters”: {“type”: “latest”}}) EOF] |
| . . . | . . . |

As shown in Table 1, taking the annotation information [SOF API_CALL({“api”: “Weather_API”, “parameters”: {“date”: “today”}}) EOF] as an example, it may include the symbol “SOF”, the symbol “API_CALL”, the symbol “EOF”, and the invocation parameter “api”: “News_API”, “parameters”: {“type”: “latest”}. The server device 120 may, for example, provide the sample query to the target machine learning model 210 and acquire, from the target machine learning model 210, an invocation marker for an invocation of a predicted plug-in and an invocation parameter for the predicted plug-in. The server device 120 may train the target machine learning model 210 based on one or more of: a difference between a sample plug-in and the predicted plug-in, a difference between an invocation marker for an invocation of the sample plug-in and an invocation marker for an invocation of the predicted plug-in, and a difference between an invocation parameter for the sample plug-in and an invocation parameter for the predicted plug-in. A training objective of the target machine learning model 210 is to make the above difference less than a threshold. The trained target machine learning model 210 may output an accurate invocation marker and an accurate invocation parameters based on the query request 201.

The server device 120 may, for example, determine the first plug-in to be invoked based on the invocation marker for the invocation of the first plug-in. The server device 120 may further invoke the first plug-in with a first invocation parameter to acquire a first invocation result of the first plug-in. It may be understood that, in a case where a plurality of first plug-ins are included, the invocation marker for an invocation of the first plug-in may include invocation markers corresponding to each of the plurality of first plug-ins, and the first invocation parameter may include invocation parameters corresponding to each of the plurality of first plug-ins. For each of the first plug-ins, the server device 120 may invoke the first plug-in based on the first invocation parameter corresponding to the first plug-in.

In some embodiments, in a case where a plurality of first plug-ins are included, each plug-in may be respectively assigned a corresponding invocation marker. For example, if three plug-ins are included, the three plug-ins may respectively correspond to three invocation markers. In some embodiments, a plurality of plug-ins may further be classified so that each plug-in may be classified into a certain plug-in category. In such a case, each plug-in category may be assigned the same invocation marker, and therefore all the plurality of plug-ins may correspond to at least one invocation marker. For example, if three plug-ins are included, of which two plug-ins are of the same category (that is, the three plug-ins are classified into two plug-in categories), then the three plug-ins may be assigned two invocation markers, one invocation marker for each plug-in category.

The server device 120 may, in response to acquiring a plurality of first invocation results corresponding to the plurality of first plug-ins, determine that all the first invocation results corresponding to the first plug-ins are acquired. In some embodiments, the server device 120 may directly determine a reply to the query request 201 based on the first invocation result. In some embodiments, the server device 120 may generate a prompt for a machine learning model based on the first invocation result and the query request 201, where the machine learning model may be the same as or different from the target machine learning model 210. Herein, the machine learning model is taken as the target machine learning model 210 for illustration. The server device 120 may guide the machine learning model to generate a model output for the query request 201 by providing the prompt to the target machine learning model 210. In this case, a reply to the query request 201 may be generated, with the aid of the target machine learning model 210, based on the first invocation result and the query request 201.

In some embodiments, the invocation marker for an invocation of the first plug-in, the first invocation parameter for the first plug-in, and the query request 201 may be directly provided together to a machine learning model (for example, the target machine learning model 210). That is, a prompt for the target machine learning model 210 may be determined based on the invocation marker for an invocation of the first plug-in, the first invocation parameter for the first plug-in, and the query request 201. In such a case, the target machine learning model 210 may directly invoke the first plug-in, acquire the first invocation result, and generate a reply based on the first invocation result. Accordingly, a plug-in may be directly invoked and a reply may be generated with the aid of the model conveniently and efficiently, which may improve the efficiency of reply generation.

In some embodiments, a knowledge base 220 may further be deployed at the server device 120, and the knowledge base 220 includes association relationship(s) between a plurality of plug-ins. The plurality of plug-ins may include a plurality of plug-ins available to a user, such as a plurality of plug-ins installed in a client device of the user or a plurality of plug-ins to which the user has usage rights. In some embodiments, the association relationship(s) between the plurality of plug-ins may be represented in the form of a knowledge graph, that is, the knowledge base 220 may include a knowledge graph formed based on plug-in information related to the plurality of plug-ins, and the plug-in information describes capabilities of the respective plug-ins. The knowledge graph integrates information and may structurally link different information. As an example, each entity in the knowledge graph (that is, each node) may be used to represent plug-in information corresponding to one plug-in, and a relationship between two entities (that is, a line between two nodes) may be used to represent an association relationship between two plug-ins.

The association relationships between the plurality of plug-ins in the knowledge base 220 may be determined based on user attributes, historical question-and-answer records, predetermined configurations, invocation parameters and invocation results of the plug-ins, and the like. As an example, if a user usually invokes plug-in B when invoking plug-in A, it may be determined that there is an association relationship between plug-in A and plug-in B. If an invocation result of plug-in C includes at least part of an invocation parameter of plug-in D, it may be determined that there is an association relationship between plug-in C and plug-in D.

The server device 120 may search the knowledge base 220 for at least one second plug-in associated with the first plug-in. It may be understood that the first plug-in may include one or more first plug-ins, and if the first plug-in includes a plurality of first plug-ins, the server device 120 may search, for each of the first plug-ins, the knowledge base for at least one second plug-in associated with the first plug-in. Referring to FIG. 2B, FIG. 2B illustrates an example of a knowledge graph 200B according to some embodiments of the present disclosure. Each entity in the knowledge graph 200B may correspond to one plug-in, that is, entities A to H in the figure respectively correspond to plug-ins A to H. As shown in FIG. 2B, if the first plug-in includes plug-in A and plug-in D, then at least one second plug-in associated with plug-in A may be determined based on the knowledge graph 200B to include plug-in B and plug-in C, and at least one second plug-in associated with plug-in D may be determined based on the knowledge graph 200B to include plug-in B and plug-in E. That is, the second plug-ins associated with the first plug-in include plug-in B, plug-in C, and plug-in E.

In some embodiments, in addition to the knowledge graph, the knowledge base 220 may further store plug-in information of a plurality of plug-ins in any other suitable manner. As an example, the knowledge base 220 may include a plurality of vectors corresponding to plug-in information of the plurality of plug-ins. A degree of association between different plug-ins may be determined by calculating similarity between different vectors. It may be determined that there is an association relationship between two plug-ins whose corresponding degree of association is greater than a threshold.

As an example, the knowledge graph may structurally link information related to weather, flights, hotels, and the like. For example, the knowledge graph may associate information such as flight arrival time, destination weather, and hotel check-in time. If a query request includes query text “I will travel to city A tomorrow, where is suitable to stay?”, it may be determined that the first plug-in may include a weather plug-in and a hotel plug-in. The server device 120 may query these two plug-ins in the knowledge base 220, and determine a transportation plug-in (for example, a flight plug-in) associated with the two plug-ins.

In some embodiments, the server device 120 may determine a second invocation parameter for at least one second plug-in based on at least one of an invocation parameter or an invocation result of the first plug-in. In some embodiments, the server device 120 may further determine a second invocation parameter for at least one second plug-in based on plug-in information of the second plug-in. For example, the server device 120 may, according to a machine learning model (for example, the target machine learning model 210), determine a second invocation parameter for at least one second plug-in from the query request 201 and context information associated with the query request 201 based on the plug-in information of the second plug-in. If the second invocation parameter cannot be determined from the query request 201 and the context information associated with the query request 201, a prompt message for acquiring the second invocation parameter may further be provided to the user to prompt the user to actively provide the second invocation parameter.

The server device 120 may invoke at least one second plug-in with the second invocation parameter to obtain a second invocation result of the at least one second plug-in. In some embodiments, since the second plug-in is not directly determined based on the query request 201, the user may not expect the second plug-in to be invoked. To avoid a situation where the server device 120 invokes a plug-in that the user does not expect to be invoked, the server device 120 may, in response to determining the second invocation parameter for at least one second plug-in, provide a confirmation prompt to the user, the confirmation prompt being used to prompt the user to confirm whether to invoke the at least one second plug-in. The server device 120 may, in response to receiving user confirmation for invoking the at least one second plug-in, invoke the at least one second plug-in with the second invocation parameter.

The server device 120 may then determine a reply to the query request 201 at least based on the first invocation result and the second invocation result. In some embodiments, if the second invocation parameter cannot be obtained or user confirmation for invoking the second plug-in is not obtained, the server device 120 may first determine a reply based on the first invocation result and provide the reply to the user. The server device 120 may then request the second invocation parameter from the user or provide the confirmation prompt for invoking the second plug-in to the user again. The server device 120 may, in response to acquiring the second invocation parameter and the user confirmation, invoke the second plug-in with the second invocation parameter to acquire the second invocation result. The server device 120 may update the previously generated reply based on the second invocation result and provide the updated reply to the user.

If the second invocation parameter is directly acquired and user confirmation is obtained, the server device 120 may directly generate a prompt for a machine learning model based on the first invocation result, the second invocation result, and the query request 201, where the machine learning model may be the same as or different from the target machine learning model 210. Herein, the machine learning model is taken as the target machine learning model 210 for illustration. The server device 120 may guide the machine learning model to generate a model output for the query request 201 by providing the prompt to the target machine learning model 210. In this case, a reply to the query request 201 may be generated, with the aid of the target machine learning model 210, based on the first invocation result, the second invocation result, and the query request 201.

In summary, according to embodiments of the present disclosure, in a case where it is determined that a plug-in needs to be invoked to determine a reply, a plug-in corresponding to a query request may be determined using a machine learning model, and a reply to the query request may be determined based on an invocation result of the plug-in. Compared with the conventional scheme of providing all plug-ins to the machine learning model, the present scheme determines which plug-ins are to be invoked with the aid of the model and invokes the plug-ins in a targeted manner, which may reduce computing power consumption of the model in processing a large number of plug-ins, and improve efficiency of invoking plug-ins and determining a reply.

FIG. 3 illustrates a flowchart of a method 300 for reply provision according to some embodiments of the present disclosure. The method 300 may be implemented at the server device 120.

At block 310, the server device 120 receives a query request.

At block 320, the server device 120 generates, using a target machine learning model, a first model output based on the query request. The first model output includes an invocation marker for an invocation of a first plug-in and a first invocation parameter for the first plug-in.

At block 330, the server device 120 invokes the first plug-in using the first invocation parameter to obtain a first invocation result of the first plug-in.

At block 340, the server device 120 determines a reply to the query request at least based on the first invocation result.

In some embodiments, the machine learning model is trained based on sample queries and annotation information for the sample queries, the annotation information at least including an invocation marker for an invocation of a sample plug-in and an invocation parameter for the sample plug-in, and the sample plug-in being invoked for determining replies to the sample queries.

In some embodiments, the invocation marker includes a sequence start symbol indicating a plug-in invocation, a plug-in invocation symbol, and a sequence end symbol indicating a plug-in invocation.

In some embodiments, determining the reply to the query request at least based on the first invocation result includes: generating, using the machine learning model, a second model output at least based on the query request and the first invocation result; and determining the reply to the query request based on the second model output.

In some embodiments, the method 300 further includes: searching a knowledge base for at least one second plug-in associated with the first plug-in, the knowledge base including an association relationship between a plurality of plug-ins; determining a second invocation parameter for the at least one second plug-in based on at least one of the invocation parameter for the first plug-in or the invocation result of the first plug-in; invoking the at least one second plug-in with the second invocation parameter to obtain a second invocation result of the at least one second plug-in; and where determining the reply to the query request includes: determining the reply to the query request based on the first invocation result and the second invocation result.

In some embodiments, the knowledge base includes a knowledge graph formed based on plug-in information related to the plurality of plug-ins, the plug-in information describing capabilities of the respective plug-ins.

In some embodiments, the plurality of plug-ins include a plurality of plug-ins available to a user.

In some embodiments, invoking the at least one second plug-in with the second invocation parameter includes: invoking the at least one second plug-in with the second invocation parameter in response to receiving a user confirmation for the at least one second plug-in.

In some embodiments, the method 300 further includes: determining, based on the first invocation result, a first reply to the query request in response to the second invocation parameter being not determined or a user confirmation for the at least one second plug-in being not received; obtaining a second invocation result of the at least one second plug-in by invoking the at least one second plug-in with the second invocation parameter in response to the second invocation parameter being determined and the user confirmation for the at least one second plug-in being received; and updating the first reply based on the second invocation result.

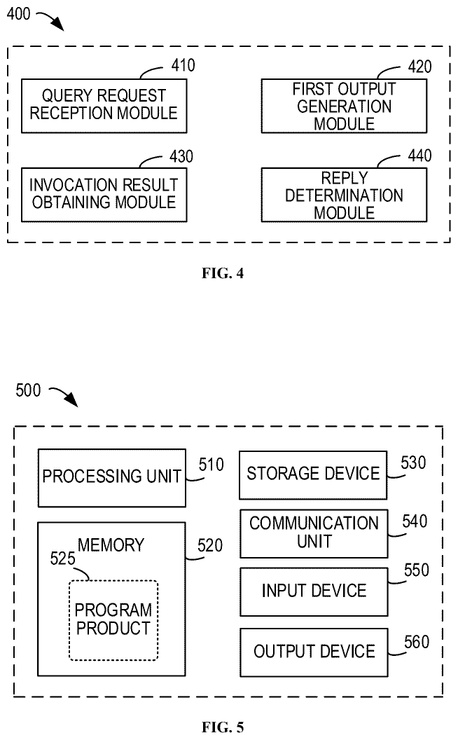

Embodiments of the present disclosure further provide a corresponding apparatus for implementing the above method or process. FIG. 4 illustrates an illustrative structural block diagram of an apparatus 400 for reply provision according to some embodiments of the present disclosure. The apparatus 400 may be implemented as, or included in, the server device 120. Each module/component in the apparatus 400 may be implemented by hardware, software, firmware, or any combination thereof.

As shown in FIG. 4, the apparatus 400 includes a query request reception module 410 configured to receive a query request. The apparatus 400 further includes a first output generation module 420 configured to generate, using a target machine learning model, a first model output based on the query request. The first model output includes an invocation marker for an invocation of a first plug-in and a first invocation parameter for the first plug-in. The apparatus 400 further includes an invocation result obtaining module 430 configured to obtain a first invocation result of the first plug-in by invoking the first plug-in using the first invocation parameter. The apparatus 400 further includes a reply determination module 440 configured to determine a reply to the query request at least based on the first invocation result.

In some embodiments, the machine learning model is trained based on sample queries and annotation information for the sample queries. The annotation information at least includes an invocation marker for an invocation of a sample plug-in and an invocation parameter for the sample plug-in, and the sample plug-in is invoked for determining replies to the sample queries.

In some embodiments, the invocation marker includes a sequence start symbol indicating a plug-in invocation, a plug-in invocation symbol, and a sequence end symbol indicating a plug-in invocation.

In some embodiments, the reply determination module 440 is further configured to: generate, using the machine learning model, a second model output at least based on the query request and the first invocation result; and determine the reply to the query request based on the second model output.

In some embodiments, the apparatus 400 further includes: a second plug-in searching module configured to search a knowledge base for at least one second plug-in associated with the first plug-in, the knowledge base including an association relationship between a plurality of plug-ins; an invocation parameter determination module configured to determine a second invocation parameter for the at least one second plug-in based on at least one of the invocation parameter for the first plug-in or the invocation result of the first plug-in; a second plug-in invocation module configured to invoke the at least one second plug-in with the second invocation parameter to obtain a second invocation result of the at least one second plug-in; and where the reply determination module 440 is further configured to determine the reply to the query request based on the first invocation result and the second invocation result.

In some embodiments, the knowledge base includes a knowledge graph formed based on plug-in information related to the plurality of plug-ins, the plug-in information describing capabilities of the respective plug-ins.

In some embodiments, the plurality of plug-ins include a plurality of plug-ins available to a user.

In some embodiments, the second plug-in invocation module is further configured to: invoke the at least one second plug-in with the second invocation parameter in response to receiving a user confirmation for the at least one second plug-in.

In some embodiments, the apparatus 400 further includes: a first reply generation module configured to determine, based on the first invocation result, a first reply to the query request in response to the second invocation parameter being not determined or a user confirmation for the at least one second plug-in being not received; a second result obtaining module configured to obtain a second invocation result of the at least one second plug-in by invoking the at least one second plug-in with the second invocation parameter in response to the second invocation parameter being determined and the user confirmation for the at least one second plug-in being received; and a first reply updating module configured to update the first reply based on the second invocation result.

The units and/or modules included in the apparatus 400 may be implemented in various ways, including software, hardware, firmware, or any combination thereof. In some embodiments, one or more units and/or modules may be implemented using software and/or firmware, for example, machine-executable instructions stored on a storage medium. In addition to, or as an alternative to, the machine-executable instructions, some or all of the units and/or modules in the apparatus 400 may be implemented at least partially by one or more hardware logic components. By way of example and not limitation, exemplary types of hardware logic components that may be used include field-programmable gate arrays (FPGAs), application-specific integrated circuits (ASICs), application-specific standard products (ASSPs), systems on a chip (SOCs), complex programmable logic devices (CPLDs), and the like.

It should be understood that one or more steps in the above method may be performed by an appropriate electronic device or a combination of electronic devices. Such an electronic device or a combination of electronic devices may, for example, include the client device 110 and/or the server device 120 in FIG. 1A.

FIG. 5 illustrates a block diagram of an electronic device 500 in which one or more embodiments of the present disclosure may be implemented. It should be understood that the electronic device 500 shown in FIG. 5 is merely illustrative, and should not be construed as imposing any limitation on the functions and scope of the embodiments described herein. The electronic device 500 shown in FIG. 5 may be used to implement the client device 110 and/or the server device 120 of FIG. 1A.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and is capable of performing various processing according to programs stored in the memory 520. In a multiprocessor system, multiple processing units may execute computer-executable instructions in parallel to enhance the parallel processing capability of the electronic device 500.

The electronic device 500 generally includes a plurality of computer storage media. Such media may be any available media accessible by the electronic device 500 and may include, but are not limited to, volatile and nonvolatile media, removable and non-removable media. The memory 520 may be volatile memory (for example, registers, cache, random access memory (RAM)), nonvolatile memory (for example, read-only memory (ROM), electrically erasable programmable read-only memory (EEPROM), flash memory), or a combination thereof. The storage device 530 may be removable or non-removable media, and may include machine-readable media such as flash drives, magnetic disks, or any other media that can be used to store information and/or data and that can be accessed within the electronic device 500.

The electronic device 500 may further include additional removable/non-removable, volatile/nonvolatile storage media. Although not shown in FIG. 5, disk drives for reading from or writing to removable, nonvolatile magnetic disks (for example, “floppy disks”) and optical disk drives for reading from or writing to removable, nonvolatile optical disks may be provided. In such cases, each drive may be connected to the bus (not shown) by one or more data media interfaces. The memory 520 may include a computer program product 525 having one or more program modules configured to perform various methods or actions of various embodiments of the present disclosure.

The communication unit 540 enables communication with other electronic devices through a communication medium. Additionally, the functions of the components of the electronic device 500 may be implemented in a single computing cluster or in multiple computing machines capable of communicating through communication connections. Therefore, the electronic device 500 may operate in a networked environment using logical connections with one or more other servers, network personal computers (PCs), or other network nodes.

The input device(s) 550 may be one or more input devices such as a mouse, a keyboard, a trackball, and the like. The output device(s) 560 may include one or more output devices such as a display, a speaker, a printer, and the like. The electronic device 500 may also communicate, as needed, with one or more external devices (not shown) via the communication unit 540, such external devices including storage devices, display devices, and the like, with one or more devices enabling a user to interact with the electronic device 500, or with any devices enabling the electronic device 500 to communicate with one or more other electronic devices (for example, network cards, modems, and the like). Such communication may be performed via an input/output (I/O) interface (not shown).

According to an illustrative implementation of the present disclosure, there is provided a computer-readable storage medium having stored thereon computer-executable instructions, the computer-executable instructions being executed by a processor to implement the method described above. According to an illustrative implementation of the present disclosure, there is further provided a computer program product, the computer program product being tangibly stored on a non-transitory computer-readable medium and including computer-executable instructions, the computer-executable instructions being executed by a processor to implement the method described above.

Various aspects of the present disclosure have been described herein with reference to flowcharts and/or block diagrams of methods, apparatuses, devices, and computer program products according to the present disclosure. It should be understood that each block in the flowcharts and/or block diagrams, and combinations of blocks in the flowcharts and/or block diagrams, may be implemented by computer-readable program instructions.

These computer-readable program instructions may be provided to the processing unit of a general-purpose computer, a special-purpose computer, or other programmable data processing apparatus to produce a machine, such that the instructions, when executed by the processing unit of the computer or other programmable data processing apparatus, implement the functions/acts specified in one or more blocks in the flowcharts and/or block diagrams. The computer-readable program instructions may also be stored in a computer-readable storage medium, which instructions cause a computer, a programmable data processing apparatus, and/or other devices to function in a particular manner, such that the computer-readable medium having the instructions stored therein includes an article of manufacture including instructions which implement aspects of the functions/acts specified in one or more blocks in the flowcharts and/or block diagrams.

The computer-readable program instructions may be loaded onto a computer, other programmable data processing apparatus, or other devices to cause a series of operational steps to be performed on the computer, other programmable data processing apparatus, or other devices to produce a computer-implemented process such that the instructions, when executed on the computer, other programmable data processing apparatus, or other devices, implement the functions/acts specified in one or more blocks in the flowcharts and/or block diagrams.

The flowcharts and block diagrams in the drawings illustrate the possible architectures, functions, and operations of systems, methods, and computer program products according to multiple implementations of the present disclosure. In this regard, each block in the flowcharts or block diagrams may represent a module, a program segment, or a portion of instructions, where the module, program segment, or portion of instructions includes one or more executable instructions for implementing the specified logical function(s). In some implementations, the functions noted in the blocks may occur in an order different from that noted in the drawings. For example, two blocks shown in succession may in fact be executed substantially concurrently, or they may sometimes be executed in the reverse order, depending upon the functionality involved. It should also be noted that each block in the block diagrams and/or flowcharts, and combinations of blocks in the block diagrams and/or flowcharts, may be implemented by a special-purpose hardware-based system that performs the specified functions or acts, or by a combination of special-purpose hardware and computer instructions.

The implementations of the present disclosure have been described above. The foregoing description is illustrative, and not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application, or technical improvements over technologies found in the marketplace, or to enable other persons of ordinary skill in the art to understand the implementations disclosed herein.

1. A method for reply provision, comprising:
receiving a query request;
generating, using a target machine learning model, a first model output based on the query request, the first model output comprising an invocation marker for an invocation of a first plug-in and a first invocation parameter for the first plug-in;
obtaining a first invocation result of the first plug-in by invoking the first plug-in using the first invocation parameter; and
determining a reply to the query request at least based on the first invocation result.

2. The method of claim 1, wherein the machine learning model is trained based on sample queries and annotation information for the sample queries, the annotation information at least comprises the invocation marker for an invocation of a sample plug-in and an invocation parameter for the sample plug-in, and the sample plug-in is invoked for determining replies to the sample queries.

3. The method of claim 1, wherein the invocation marker comprises a sequence start symbol indicating a plug-in invocation, a plug-in invocation symbol, and a sequence end symbol indicating a plug-in invocation.

4. The method of claim 1, wherein determining the reply to the query request at least based on the first invocation result comprises:
generating, using the machine learning model, a second model output at least based on the query request and the first invocation result; and
determining the reply to the query request based on the second model output.

5. The method of claim 1, further comprising:
searching a knowledge base for at least one second plug-in associated with the first plug-in, the knowledge base comprising an association relationship between a plurality of plug-ins;
determining a second invocation parameter for the at least one second plug-in based on at least one of the invocation parameter for the first plug-in or the invocation result of the first plug-in; and
obtaining a second invocation result of the at least one second plug-in by invoking the at least one second plug-in with the second invocation parameter,
wherein determining the reply to the query request comprises: determining the reply to the query request based on the first invocation result and the second invocation result.

6. The method of claim 5, wherein the knowledge base comprises a knowledge graph formed based on plug-in information related to the plurality of plug-ins, and the plug-in information describes capabilities of the respective plug-ins.

7. The method of claim 5, wherein the plurality of plug-ins comprise a plurality of plug-ins available to a user.

8. The method of claim 5, wherein invoking the at least one second plug-in with the second invocation parameter comprises:
invoking, in response to receiving a user confirmation for the at least one second plug-in, the at least one second plug-in with the second invocation parameter.

9. The method of claim 5, further comprising:
determining, based on the first invocation result, a first reply to the query request in response to the second invocation parameter being not determined or a user confirmation for the at least one second plug-in being not received; and
in response to the second invocation parameter being determined and a user confirmation for the at least one second plug-in being received,
obtaining a second invocation result of the at least one second plug-in by invoking the at least one second plug-in with the second invocation parameter, and
updating the first reply based on the second invocation result.

10. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
receiving a query request;
generating, using a target machine learning model, a first model output based on the query request, the first model output comprising an invocation marker for an invocation of a first plug-in and a first invocation parameter for the first plug-in;
obtaining a first invocation result of the first plug-in by invoking the first plug-in using the first invocation parameter; and
determining a reply to the query request at least based on the first invocation result.

11. The electronic device of claim 10, wherein the machine learning model is trained based on sample queries and annotation information for the sample queries, the annotation information at least comprises the invocation marker for an invocation of a sample plug-in and an invocation parameter for the sample plug-in, and the sample plug-in is invoked for determining replies to the sample queries.

12. The electronic device of claim 10, wherein the invocation marker comprises a sequence start symbol indicating a plug-in invocation, a plug-in invocation symbol, and a sequence end symbol indicating a plug-in invocation.

13. The electronic device of claim 10, wherein determining the reply to the query request at least based on the first invocation result comprises:
generating, using the machine learning model, a second model output at least based on the query request and the first invocation result; and
determining the reply to the query request based on the second model output.

14. The electronic device of claim 10, wherein the acts further comprise:
searching a knowledge base for at least one second plug-in associated with the first plug-in, the knowledge base comprising an association relationship between a plurality of plug-ins;
determining a second invocation parameter for the at least one second plug-in based on at least one of the invocation parameter for the first plug-in or the invocation result of the first plug-in; and
obtaining a second invocation result of the at least one second plug-in by invoking the at least one second plug-in with the second invocation parameter,
wherein determining the reply to the query request comprises: determining the reply to the query request based on the first invocation result and the second invocation result.

15. The electronic device of claim 14, wherein the knowledge base comprises a knowledge graph formed based on plug-in information related to the plurality of plug-ins, and the plug-in information describes capabilities of the respective plug-ins.

16. The electronic device of claim 14, wherein the plurality of plug-ins comprise a plurality of plug-ins available to a user.

17. The electronic device of claim 14, wherein invoking the at least one second plug-in with the second invocation parameter comprises:
invoking, in response to receiving a user confirmation for the at least one second plug-in, the at least one second plug-in with the second invocation parameter.

18. The electronic device of claim 14, wherein the acts further comprise:
determining, based on the first invocation result, a first reply to the query request in response to the second invocation parameter being not determined or a user confirmation for the at least one second plug-in being not received; and
in response to the second invocation parameter being determined and a user confirmation for the at least one second plug-in being received,
obtaining a second invocation result of the at least one second plug-in by invoking the at least one second plug-in with the second invocation parameter, and
updating the first reply based on the second invocation result.

19. A non-transitory computer-readable storage medium having stored thereon a computer program executable by a processor to perform acts comprising:
receiving a query request;
generating, using a target machine learning model, a first model output based on the query request, the first model output comprising an invocation marker for an invocation of a first plug-in and a first invocation parameter for the first plug-in;
obtaining a first invocation result of the first plug-in by invoking the first plug-in using the first invocation parameter; and
determining a reply to the query request at least based on the first invocation result.

20. The non-transitory computer-readable storage medium of claim 19, wherein the machine learning model is trained based on sample queries and annotation information for the sample queries, the annotation information at least comprises the invocation marker for an invocation of a sample plug-in and an invocation parameter for the sample plug-in, and the sample plug-in is invoked for determining replies to the sample queries.
